(19) United States
(12) Patent Application Publication
(10) Pub. No.: US 2026/0097453 A1
(43) Pub. Date: Apr. 9, 2026

(54) BONDING ELEMENT FOR DIFFUSION BONDING, COMPRISING A HEATING ELEMENT AND A BONDING STRUCTURE WITH AN OUTER METAL SURFACE

(71) Applicant: Tokamak Energy Ltd, Oxfordshire (GB)

(72) Inventor: Simon Hanks, Oxfordshire (GB)

(21) Appl. No.: 19/115,073

(22) PCT Filed: Sep. 25, 2023
(86) PCT No.: PCT/EP2023/076369

§ 371 Date: Mar. 25, 2025

(30) Foreign Application Priority Data
Sep. 26, 2022 (GB) 2214007.3

(51) Int. Cl. B23K 35/00; B23K 20/02; B23K 35/28; B23K 103/10

(52) U.S. Cl. CPC B23K 35/001; B23K 20/023; B23K 35/286; B23K 2103/10

(57) ABSTRACT

A bonding element suitable for diffusion bonding two components includes a sealing structure for locating between the two components; and a heating element connected to the sealing structure and configured to provide local heating to the sealing structure sufficient to cause the sealing structure to diffusion bond to each of the two components and provide a seal between them.

### CROSS-REFERENCE TO RELATED APPLICATIONS

This application is the U.S. National Stage entry of International Application No. PCT/EP2023/076369, filed on Sep. 25, 2023, which, in turn, claims priority to GB Patent Application No. 2214007.3, filed on Sep. 26, 2022, both of which is are hereby incorporated herein by reference in their entireties for all purposes.

### TECHNICAL FIELD

The present invention relates to bonding elements for bonding components and methods of bonding.

### BACKGROUND

In many industries reliable seals between components, such as between the flanges of joined pipe sections, are important. In some situations, a gasket or a spring-energised metal seal may be sufficient to provide a hermetic seal between the components when under compression. For high temperature and high pressure applications or where adequate compression cannot be maintained, it may be necessary to permanently join the components by, for example, fusion welding or brazing. This is not always possible and may damage the components to be joined.

Diffusion bonding is a solid-state technique used for permanently joining components. It operates on the principle of solid-state diffusion, wherein the atoms of two solid, e.g. metallic, surfaces intersperse themselves over time. It may be used to join similar or dissimilar materials including a wide range of metals, alloys and ceramic materials including aluminium alloys, titanium alloys, steels, copper alloys, silicon carbide (SIC), silicon nitride (Si3N4) and metal matrix composites. Diffusion bonding is usually implemented by applying high pressure and temperature (though below the lowest melting point of the respective components or any interlayers) to the components to be joined in a vacuum or inert gas environment.

FIG. 1 shows a schematic diagram of a system 1 for diffusion bonding. Two parts 2 are pressed together by a hydraulic press 3 and heated by heaters 4 in an evacuated furnace 5 to cause bonding between the parts 2. Diffusion bonding is used in a broad range of industries but, due to the need to place the components within a suitable furnace 5 and heat them for extended periods of time, is typically only used for manufacturing relatively small assemblies of components.

### SUMMARY OF INVENTION

In one aspect, the present invention provides, a method of bonding two components, the method including: locating a bonding element including a bonding structure and a heating element between the two components; compressing the bonding element between the two components; and heating the bonding structure with the heating element to cause the bonding structure to diffusion bond to each of the two components and to provide a bond between them. Advantageously, by locating the bonding structure and heating element between the two components, diffusion bonding can be achieved by providing only local heating to the bonding structure rather than placing the assembly in a furnace. This enables diffusion bonding to be used on larger assemblies and/or consuming less heating energy than previously possible. For example, diffusion bonding may be used to create a permanent seal between parts of a vacuum chamber or large pipe sections.

At least an outer surface of the bonding structure includes a material suitable for diffusion bonding to each of the two components such as a metal or, in some embodiments, aluminium.

In another aspect, the present invention provides a bonding element for bonding (e.g. suitable for diffusion bonding) two components, the bonding element including: a bonding structure having an outer metal surface; and a heating element (e.g., a resistive heating element) proximate to the bonding structure (e.g., such that the heating element provides localised heating to the bonding structure in use); wherein the bonding element is configured for locating between the two components and the heating element is configured to heat the bonding structure sufficiently to cause the outer metal surface of the bonding structure to bond to each of the two components in use.

The bonding element may include a spring-energised metal seal, the heating element including a helical spring of the spring-energised metal seal and the bonding element including a sealing jacket at least partially around the helical spring. In this embodiment, locating the bonding element between the two components is able to create a seal between the components which is then made permanent by internally heating the bonding element to bond it to each of the components. In a typical spring-energised metal seal, both the spring and the outer jacket form a closed loop. In this embodiment, the spring does not form a closed loop (e.g., it has at least one separation) such that a voltage can be applied across it.

In another aspect, the present invention provides a bonding element for bonding two components, the bonding element including: a bonding structure for locating between the two components; and a heating element connected to the bonding structure and configured to heat the bonding structure sufficiently to cause the bonding structure to bond to each of the two components. The bonding structure therefore bonds the two components together. The bonding structure may be a sealing structure (e.g., includes a closed loop) that also provides a seal between the two components when used for bonding. The bonding or sealing structure may comprise a metal (e.g., aluminium) surface (e.g. a shell, jacket or foil) at least partially enclosing the heating element. The bonding or sealing structure may therefore be configured for diffusion bonding of its metal surface to respective surfaces of the two components in use (e.g., aluminium diffusion bonding).

In another aspect, the present invention provides a method of bonding two components, the method including: providing a bonding element including a bonding structure and a heating element, wherein the heating element is connected to the bonding structure; locating the bonding element between the two components; applying pressure to the bonding element via the two components; and, with the heating element, heating the bonding structure to cause the bonding structure to bond to each of the two components. The bonding structure may be a sealing structure (e.g., includes a closed loop) such that causing the bonding structure to bond to each of the two components also includes providing a seal between them.

### BRIEF DESCRIPTION OF THE DRAWINGS

Embodiments of the invention will now be described with reference to the accompanying drawings, in which:

FIG. 1 shows a schematic diagram of a system for diffusion bonding;

FIG. 2 shows a schematic diagram of a bonding element;

FIG. 3 shows a schematic diagram of two components being bonded by a bonding element;

FIG. 4 shows a schematic cross section of a bonding element; and

FIG. 5 shows a flow diagram of a method of bonding.

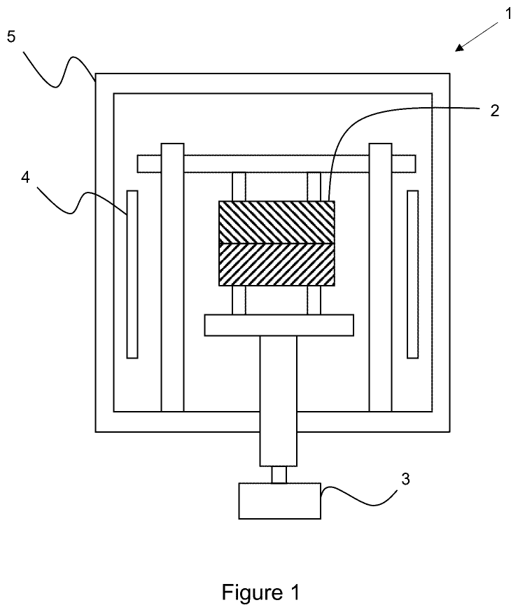

### DETAILED DESCRIPTION

Embodiments described herein provide a bonding element for bonding two components. The bonding element includes a bonding structure for locating between the two components, and a heating element proximate to the bonding structure and configured to provide local heating to the bonding structure sufficient to cause the bonding structure to diffusion bond to each of the two components, thereby bridging the two components and bonding them together. Conveniently, when formed as a closed loop for example, the bonding structure can also be used as a sealing structure that provides a seal between the two components when used for bonding. The description below focuses on embodiments of the invention where the bonding element includes a sealing structure, though it will be recognised that the provision of a local heating element is advantageous for bonding structures generally suitable for diffusion bonding.

The sealing structure may include a metal or any other suitable material that can form a diffusion bond with the components to be joined. Aluminium, for example, can form a diffusion bond with a wide range of metals, ceramics, glasses and crystalline solids. The sealing structure may thus be configured for aluminium diffusion bonding and forms a bonding interlayer or structure between the two components. The choice of material for the sealing structure may depend on the material of the facing surfaces of the components to be joined. These surfaces may include any suitable material, including metals (e.g. copper), ceramics, glasses or crystalline solids. The components (and/or their facing surfaces) may include the same or different materials. For example, the bonding element may be arranged to provide a seal between a metal component and a ceramic component.

The sealing structure may include a metal jacket, foil or shell at least partially enclosing the heating element, i.e., the heating element is an internal heating element to the sealing structure. The sealing structure may include a metal tube. For example, the sealing structure may be an aluminium tube with the heating element located inside the tube. The heating element is typically a resistive heating element. A current can be passed through the resistive element to generate heat and thereby heat the sealing structure. The resistive heating element may include any material with sufficient power density to provide the required heating. For example, the resistive heating element may include one or more of nickel, chromium, iron or aluminium. For example, the resistive heating element may include Nichrome or Kanthal®. The resistive material of the electrical heating element will be insulated from the sealing structure (and the components to be joined). For example, the heating element may include a mineral insulated heater such as a magnesium oxide (MgO) coated metal element.

The sealing structure includes an opening configured to provide access to the heating element. For example, in the case of a tube, the tube may include one or more openings for electrical connections to the heating element.

Each of the components may includes a flange, wherein the bonding element is configured to be located between the flanges when bonding. For example, the sealing structure may form a loop. The sealing structure may be substantially circular. For example, the sealing structure may include a circular aluminium tube.

The bonding element may be configured to provide a permanent hermetic seal between the two components for an ultra-high vacuum, UHV, environment. For example, a bonding element configured to provide an interlayer aluminium diffusion bond between two components can provide a permanent hermetic seal for UHV.

Embodiments described herein further provide a method of bonding two components. The method includes providing a bonding element including a sealing structure and a heating element, wherein the heating element is connected to the sealing structure, locating the bonding element between the two components, applying pressure to the bonding element via the two components, and with the heating element, heating the sealing structure to cause the sealing structure to bond to each of the two components and provide a seal between them. The bonding element may be a bonding element as described above. Typically, the method includes aluminium interlayer diffusion bonding. For example, the sealing structure can include aluminium, and heating the sealing structure under pressure causes aluminium diffusion bonding between the sealing structure and each of the two components.

The two components may include flanges. The step of heating may include applying a voltage across the heating element. Typically the heating element is a resistive heating element.

The sealing structure may be heated to a temperature in the range of 400° C. to 600° C., and for a time in the range of 0.5 h to 12 h, and with a line load (pressure) in the range of 80 N/mm to 120 N/mm. For example, the sealing structure may be heated with the heating element to a temperature of 500° C. for a time in the range of 0.5 h to 1 h, while applying line load of 100 N/mm. In other embodiments, a lower pressure (<100 N/mm) may be used for a longer time (>1 h) to create a sufficient seal.

Diffusion bonding, particularly with aluminium, normally requires a furnace enclosure, which ideally is evacuated to a pressure of less than 1×10⁻⁴ mbar, as well as the capability of applying axial forces on the items being bonded typically in the order of 60 KN, for bond elements of developed lengths up to approximately 600 mm. Such furnaces can be expensive and consume substantial amounts of energy. Furthermore, there is a strict limitation on the size of workpiece that may be accommodated in such a facility.

Embodiments of the present invention can at least partly overcome these problems by directly heating the material from which the bond is formed. By providing localised heating, less energy may be expended and the same size restrictions may not apply. The bonding element and method may thereby be suitable for sealing between parts of a fusion reactor or other large structures where the seal integrity in a potentially harsh environment is important.

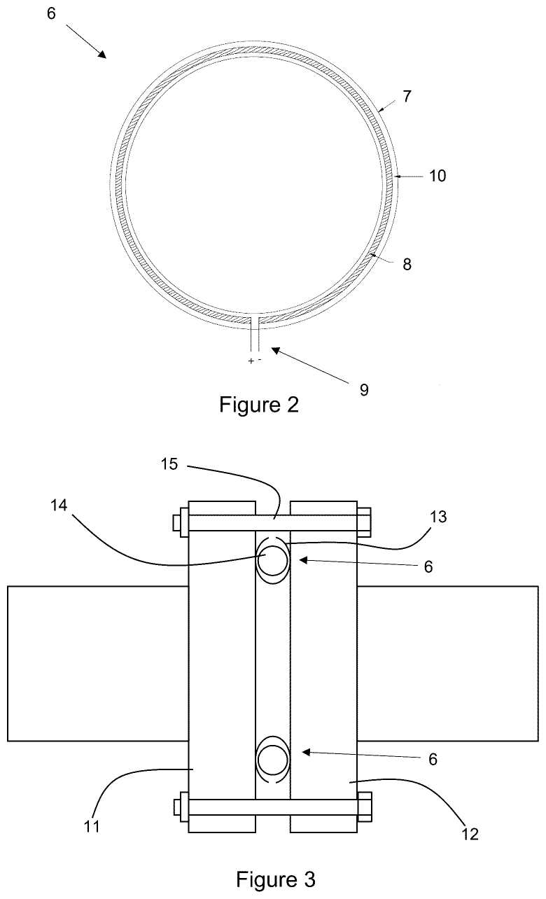

FIG. 2 is a schematic diagram of an embodiment of a bonding element 6 including a sealing structure being an aluminium tube 7 formed into a circle, though any shape of closed loop could be used as a sealing structure, and a heating element being a resistive heating element 8 connectable to a power source via an output 9. The heating element is enclosed by the sealing structure. The resistive heating element 8 includes insulation 10 for electrically insulating the heating element from the sealing structure. The heating element may be a mineral insulated (MI) heating element, and the insulation 10 may include a magnesia (MgO) coating. In use, the bonding element is provided between two components to be bonded and heated under pressure to cause diffusion bonding between the aluminium tube 7 and the components. The components may include metal, ceramics or glass for example.

The resistive heating element 8 may include one or more of nickel, chromium, iron, aluminium. For example, the resistive heating element 8 may include Nichrome or Kanthal®. Nichrome is a family of alloys including nickel and chromium that can be used as resistance wire for heating elements. Kanthal® is the trademark for a family of iron-chromium-aluminium (FeCrAl) alloys used in a range of resistance and high-temperature applications. Kanthal FeCrAl alloys consist of mainly iron, chromium (20-30%) and aluminium (4-7.5%). These materials may be particularly suitable for providing sufficient power density for the required heating. The heating element may be formed as a spring with a break for applying a voltage across the spring to cause heating. In other embodiments, the sealing structure includes an aluminium coating on another material (e.g. a metal alloy). For example, the sealing structure may include Inconel® or steel (e.g. e.g. stainless steel, austenitic stainless steel, iron alloyed with chromium and nickel) with an aluminium coating for diffusion bonding. InconeI® is the trademark for a family of austenitic nickel-chromium-based alloys. Inconel alloys can be oxidation-corrosion-resistant and suitable for service in extreme environments subjected to high pressures and heat.

In one embodiment, a mineral insulated (MI) heating element (i.e., a resistive wire coated with MgO) is surrounded by an aluminium tube, which may have been welded into the form of a closed loop. In this embodiment, the aluminium tube can be cut on the outer equatorial region, so that, in cross section, the tube has the form of a C. The heating element can then be introduced radially to sit inside the aluminium tube, with the cold ends and terminations protruding out of the cut. Alternatively, if a single-ended termination MI heater is used, the tube can have a single tangential drilling/hole, through which the closed end of the element is passed, enabling the heated section to have a closed path around the inside of the aluminium tubular loop.

FIG. 3 is a schematic cross section of two metal parts including flanges 11, 12 in the process of being bonded by a bonding element 6. The bonding element 6 includes an outer metal shell 13 (e.g. including aluminium) being an open tube (i.e., a split tube having a C-shaped cross section) partly enclosing a heating element 14. The heating element 14 may be a resistive heating element The opening in the metal shell 13 allows for external connections to the heating element 14. The flanges 11, 12 are joined by bolts 15 which cause pressure to be applied to the bonding element 6 between the flanges 11, 12. Other means such as hydraulic press may be used for pressing the metal parts together during bonding. The bonding process can take several hours for a sufficiently strong seal to form and the required time can depend on the amount of heat and pressure applied as well as on the specific metals used for bonding.

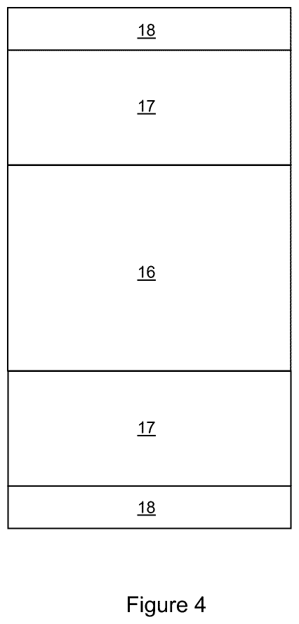

FIG. 4 shows a schematic cross section of a part of a bonding element according to an embodiment. The bonding element includes an inner heating element 16, a jacket or tube 17 at least partially enclosing the heating element 16, and an outer bonding layer 18 on the jacket 17. The heating element 16 may include a metal coil or spring having an outer electrically insulating layer. The jacket 17 may be formed from a metal such as InconeI® or stainless steel or another suitable thermally conductive material that can provide structural stability and the required shape for the bonding element. The outer layer 18 provides appropriate bonding properties for creating a diffusion bond and may include a metal such as aluminium. In use, heat is transferred from the heating element 16 to the outer layer 18 via the metal jacket 17 to cause the outer layer 18 to diffusion bond to adjacent components under compressive pressure and other suitable environmental conditions such as vacuum or an inert gas environment.

For some applications, the seal created between metal parts needs to operate in an environment with an ultra-high vacuum (UHV). UHV is the vacuum regime characterised by pressures lower than about 100 nanopascals (7.5×10⁻¹⁰ Torr). UHV conditions are created by pumping the gas out of a UHV chamber. Embodiments of the bonding element disclosed herein may be suitable for sealing a UHV chamber.

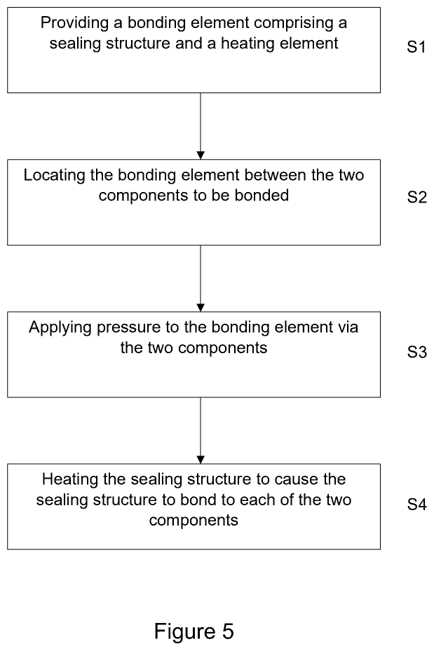

FIG. 5 is a flow diagram illustrating the steps of a method of bonding two components. The method includes providing a bonding element including a sealing structure and a heating element S1, and locating the bonding element between the components S2. The bonding element may be a bonding element as described herein, for example including an aluminium tube or sheath and a resistive heating element such as an insulated coiled wire. The method further includes applying pressure to the bonding element via the two components S3, and heating the sealing structure to bond to each of the two components S4. For example, the components may be pressed apart so as to apply a line load of about 100 N/mm to the bonding element, while the heating element heats the sealing structure to a temperature of about 500 C. At this temperature and pressure, a sufficient seal may be formed in about 0.5 h to 1 h.

While specific embodiments have been described it will be appreciated that further embodiments falling within the scope of the claims may be implemented by the skilled person. Any feature of one embodiment may be suitably combined with the features of other embodiments.

1. A method of bonding two components, the method comprising:
locating a bonding element comprising a bonding structure and a heating element between the two components;
compressing the bonding element between the two components; and
heating the bonding structure with the heating element to cause the bonding structure to diffusion bond to each of the two components to bond the two components together.

2. The method according to claim 1 wherein the bonding structure comprises a sealing structure that creates a seal between the two components.

3. The method according to claim 2, wherein the two components comprise flanges of a vacuum chamber.

4. The method according to claim 1, wherein the heating element is located within the bonding structure.

5. The method according to claim 1, wherein said step of heating comprises passing a current through the heating element.

6. The method according to claim 1, wherein an outer surface of the bonding structure comprises a material suitable for diffusion bonding to each of the two components.

7. The method according to claim 6, wherein the material comprises a metal.

8. The method according to claim 6, wherein the material comprises aluminium.

9. The method according to claim 1, wherein the bonding structure is heated with the heating element to a temperature of 500° C. for a time in the range of 0.5 h to 1 h, and wherein the step of compressing comprises applying a line load of approximately 100 N/mm.

10. A bonding element for bonding two components, the bonding element comprising:
a bonding structure having an outer metal surface; and
a heating element proximate to the bonding structure;
wherein the bonding element is configured for locating between the two components and the heating element is configured to heat the bonding structure to cause the outer metal surface of the bonding structure to bond to each of the two components in use.

11. The bonding element according to claim 10, wherein the heating element is within the bonding structure.

12. The bonding element according to claim 10, wherein the bonding structure comprises a jacket at least partially around the heating element.

13. The bonding element according to claim 12, wherein the outer metal surface of the bonding structure comprises a metal coating on the jacket.

14. The bonding element according to claim 10, wherein the outer metal surface comprises aluminium.

15. The bonding element according to claim 10, wherein the heating element comprises a mineral insulated heating element.

16. The bonding element according to claim 10, wherein the bonding structure comprises a closed loop.

17. The bonding element according to claim 16, wherein the bonding structure comprises a metal tube.

18. The bonding element according to claim 16, wherein the bonding structure has a C-shaped cross section.

19. The bonding element according to claim 10, wherein the bonding element comprises a spring-energised metal seal, the heating element comprising a helical spring of the spring-energised metal seal and the bonding element comprising a jacket at least partially around the helical spring.

20. A bonding element for bonding two components, the bonding element comprising:
a bonding structure for locating between the two components; and
a heating element connected to the bonding structure and configured to heat the bonding structure sufficiently to cause the bonding structure to bond to each of the two components;
wherein the bonding structure comprises a metal surface at least partially enclosing the heating element and is configured for diffusion bonding to the two components.

21. The bonding element according to claim 20, wherein the metal surface comprises a shell or foil.

22. The bonding element according to claim 20, wherein the bonding structure comprises a sealing structure that provides a seal between the two components when used for bonding.

23. The bonding element according to claim 20 wherein the metal comprises aluminium and the bonding structure is configured for aluminium diffusion bonding to the two components.
